(19) United States
(12) Patent Application Publication
(10) Pub. No.: US 2022/0166903 A1
(43) Pub. Date: May 26, 2022

(54) UNIVERSAL MOUNTING CASE FOR VIDEO CAMERAS

(71) Applicant: Denis N. Savelyev, Sochi (RU)

(72) Inventors: Denis N. Savelyev, SOCHI (RU); Evgeniy A. Ignatov, Ruazan (RU)

(21) Appl. No.: 17/442,458

(22) PCT Filed: Mar. 23, 2020
(86) PCT No.: PCT/RU2020/000155

§ 371 Date: Sep. 23, 2021

(30) Foreign Application Priority Data
Mar. 27, 2019 (RU) 2019108792

(51) Int. Cl. H04N 5/225

(52) U.S. Cl. CPC H04N 5/2252; H04N 5/22521

(57) ABSTRACT

The present invention relates to the field of electronic and television engineering, and more particularly to outdoor surveillance equipment. A universal mounting case for video cameras is configured in the form of a truncated sphere and comprises a case body, a case insert, and a case cover, wherein the case body is configured as a one-piece structure combining a case bottom having water drainage channels, mounting feet and breakaway ports for the switching of cable connectors, and a side wall sector having breakaway ports, an opening in its upper part for the insertion of cable connectors and locking elements for fastening to the cover, wherein the water drainage channels are configured on the inside surface of the case bottom and are in the form of gutters, the direction and height of which vary in order to hinder water from entering the case, and the mounting feet are configured so as to extend outward from the surface of the bottom by several millimeters, thus making it possible to offset the bottom of the case body from a wall; the case insert is in the form of a portion of the side sector of the body having a spherical shape, the inner side of which is provided with a breakaway port and with clips designed for reliable locking engagement in the case body, and the outer side of the insert has a locking member for the cover, said locking member being configured in the form of a tab, wherein the case insert also has holes for fixing the insert, together with the body, to a mounting surface by means of fastening elements; and the cover is spherically shaped, has four breakaway ports, locking clips arranged on four sides of the article, and guides which align with recesses for fastening members on the body and the insert. This combination of features provides the technical result of improving the technical and operational characteristics of the article, improving handling safety and improving appearance.

The present invention relates to the field of electronic television technology, namely, outdoor surveillance equipment.

A spherical chamber is known from the prior art (patent CN206807604 (U) from 2017 Dec. 26), which includes a base with a cover for communications, a rotary mechanism, a cover blocking a spherical chamber, a spheroid and a ball cover, the ball cover passes through the guide assembly, connected to the base, the ball cap may be parallel to the direction of the holding surface of the base, the hinge is articulated in the ball cap, and can be in the perpendicular direction of the holding surface. In this design, the video camera and the back case/box are combined into one design solution. This solution is highly specialized and does not allow working with individual domes or bullet cameras from different manufacturers. In this regard, there is no possibility of using this product as a convenient, aesthetic, versatile and, at the same time, a budget mounting case/box for cameras of various manufacturers, standard sizes and methods of mounting holes location.

Known mounting case/boxes from Hikvision for outdoor spherical cameras, which contain a mounting platform, horizontal and vertical camera mounts, a protective casing and a dome cover. The prototype is the Hikvision DS-1260ZJ mounting case/box (htps://hikvision.ni/product/ds 1260zj), which consists of a cylindrical base with side holes for wires and cables. The disadvantages of these devices are the increased laboriousness of installation and maintenance, a small amount of internal space for laying cables and connectors, high cost and narrow specialization, that is, the limitation of the possibility of using the installation boxes of this company in conjunction with video cameras of another manufacturer.

As many years of practice have shown, there is a fairly wide range of video cameras that require the use of mounting boxes and brackets, such as wall brackets, brackets for installation on a vertical pole, brackets for installation in a corner.

First of all, the need to use wiring case/boxes together with video cameras is due to the fact that the connection cables of the video camera and sources require protection from external influences. Primarily from moisture and dust. In addition, the cable connectors and the cables themselves must be hidden somewhere. For these purposes, mounting case/boxes are used.

In analog designs, holes for mounting screws, threaded mounting holes for installing a camera, as well as the contour formed between the body and the case/box lid, serve as an additional source of moisture penetration into the case/box, which leads to failure of the cable connectors. A sealing element is placed in the circuit between the body and the case/box lid, however, this does not guarantee protection of this circuit from moisture penetration, due to the possibility of its jamming and deformation. All these factors, despite the use of relatively strong aluminum alloys, often do not provide adequate protection for cable connectors, and also complicate and slow down the installation process.

Threaded mounting holes for installing a camera in metal housings of analogs, as a rule, are stained, which leads to the formation of a layer of paint on the thread surface, which creates significant complications when screwing in screws during the installation of a video camera on the end cover of the case/box. This often complicates and slows down the installation process.

In the designs of some types of mounting case/boxes, when the end cover is mounted on the case/box body, a contour is formed at their contact point, which requires sealing. For this purpose, a sealing gasket is used, the need to align which creates significant difficulties during installation. In addition, in analogs, the opening/closing of the case/box is carried out in the vertical direction. Since the mounting holes, threaded mounting holes for installing the camera, like the camera itself, are located on the end cover of the case/box, and the cable connectors are inside the back case/box, it will be necessary to perform maintenance on these cable connectors, for example, in the event of an interruption in the video signal from the camera. first dismantle the video camera itself, then disassemble the back case/box. Only then will there be access to the cable connectors, and, therefore, it will be possible to establish the cause of the malfunction and then eliminate it. In this case, the use of this design turns out to be extremely inconvenient. This is due to the fact that the video camera, as a rule, is mounted/dismantled at a height, and both hands are required to work with the connectors, but the camera itself must also be kept close to the place of its installation/maintenance, for which installers, as a rule, have to press the camera head-to-shoulder, or by holding the camera by the cable connectors, which greatly increases the risk of injury, falling camera, fasteners, or tools. In addition, due to the need to endure the above-described inconveniences, nervous and physical strain occurs in the body, which increases physical and mental fatigue, and also leads to such negative consequences as headache, poor sleep, chronic fatigue, pinched nerves, deterioration of vision, deterioration of blood supply to muscles, puffiness of the face, early appearance of wrinkles, deterioration of the supply of oxygen to the brain. A decrease in the supply of oxygen to the brain leads to a general decrease in a person's personal efficiency, memory impairment, contributes to the development of destructive processes in the brain, etc. However, in the case of maintenance, the inconvenience in working with this type of mounting case, box design does not end even after finding and eliminating the malfunction in the cable connectors, since then it is necessary to install the end cover of the case/box on the case, fixing it with the fastening screws. Due to the fact that the video camera has undergone movement, it will be necessary to re-focus it. All this slows down and complicates the process of video camera installation, and also increases the danger of the work being done.

In the designs of analogs, made of aluminum alloy, as a rule, there is one point for cable connectors from below and two points on the side wall. It is not possible to arrange other access points. This limits the variability of the cable connection. Constructions of plastic analogs, as a rule, have several predetermined points of entry. They also allow you to drill the necessary holes anywhere. Plastic counterparts provide great variability in the supply of cable connectors, however, the need to drill additional holes leads to an increase in time and labor costs.

In the case of using metal analogs of this product, there is a danger of a parasitic electrical potential between the conductive surface and the video camera body, which is excluded in the universal mounting case/box, since the video camera is installed on a dielectric surface.

The proposed technical solution is aimed at solving the following problems:
the use of a mounting case/box for video cameras of various form factors (versatility),
simplification of installation and maintenance of CCTV cameras,
accelerating the installation and maintenance of CCTV cameras,
variability of cable connectors supply,
protection of cable connectors,
improving the aesthetics of sealing bushings, p1 dielectric protection,
ensuring anti-vandalism,
the production of a sound signal informing about the correct assembly of product elements,
increasing the safety of installation work.

The tasks are solved due to the fact that the universal mounting case/box for video cameras includes a case/box body with a hole on the top for entering cable connectors, also contains a case/box cover, a case/box insert and a case/box bottom, while the case/box insert is part of the side sector of the body, on the inside which has latches designed for secure fixation in the case/box body. The back case/box is shaped like a truncated sphere. The case/box body is made as a single one-piece structure. The bottom of the case/box contains drainage channels, made on the inner surface of the bottom of the case/box and representing gutters that change their direction and height in order to make it difficult for water to enter the case/box. The casing, cover and insert contain cut-out windows for commutation of cable connectors. The case/box at the bottom contains fixing legs, made in such a way that they protrude outward from the bottom plane by a few millimeters, which makes it possible to move the bottom of the case/box body away from the wall. The case/box body, lid, and insert contain fasteners, including latches, notches, and guides, to securely hold all device parts. The mounting case/box contains a side seal, installed in the windows under the breakout, with several steps for supplying various communications. The steps of the side seal are made with diameters of 5 mm, 16 mm and 20 mm. At the base of the lid there are openings made in the form of rectangular cutouts.

The technical result provided by the given set of features is to improve the technical and operational characteristics of the product, increase the safety of the work performed, and improve aesthetics.

The universal mounting case/box is made of durable plastics with the addition of fillers to improve the performance of the product.

The invention is illustrated by the figures, which depict:

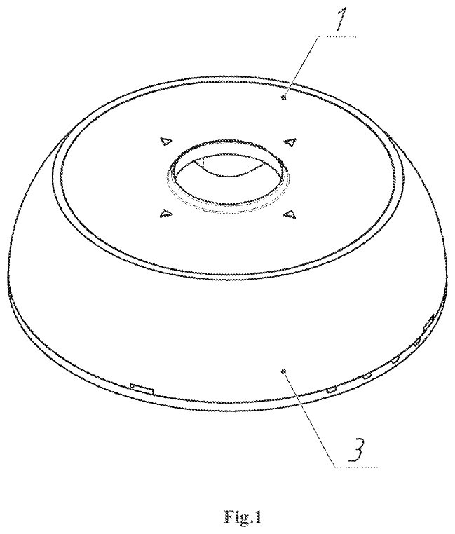

FIG. 1. is a general view of the mounting case;

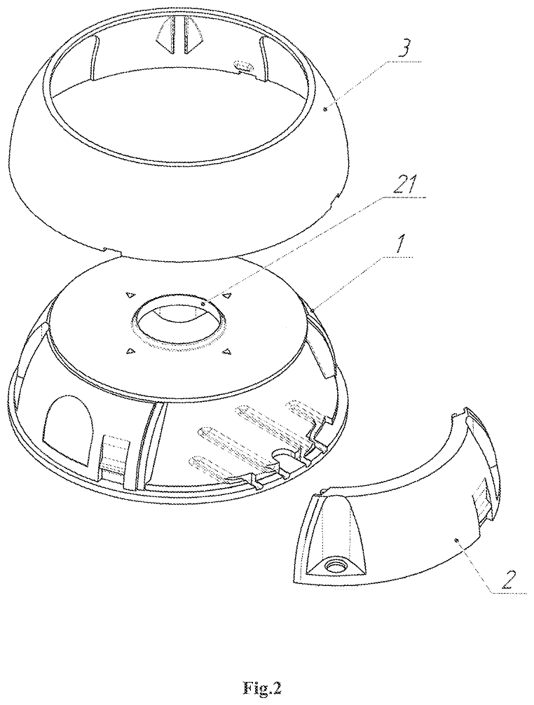

FIG. 2 is an exploded view of a mounting case;

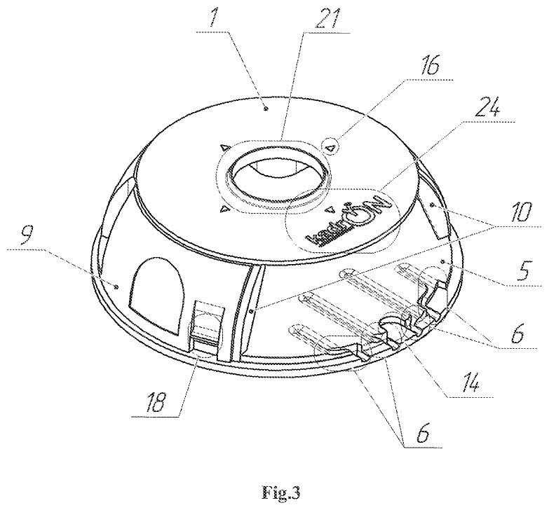

FIG. 3 is a view of the mounting case without a cover,

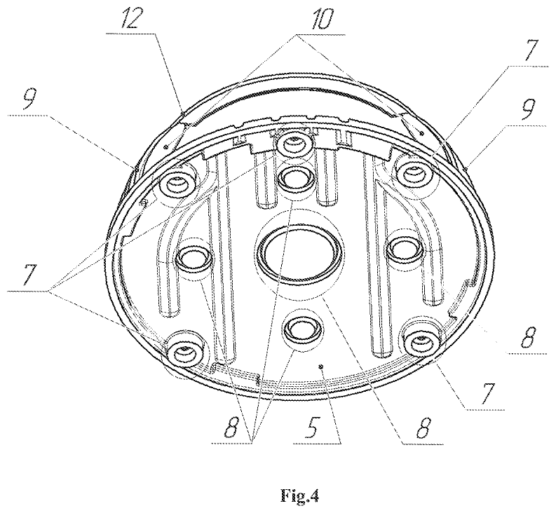

FIG. 4 is a bottom view of the mounting box/case without a cover;

FIG. 5 is a front view of the mounting case insert,

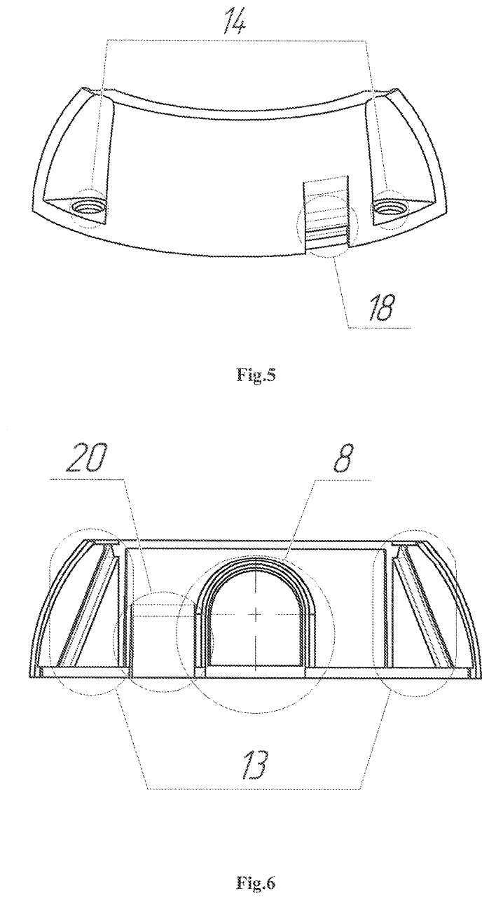

FIG. 6 is a rear view of the mounting case insert;

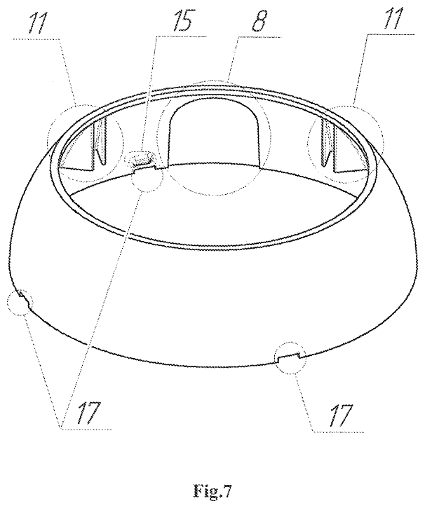

FIG. 7 is a view of the mounting case cover;

FIG. 8 shows the path of the outflow of water through the drainage channels in the case;

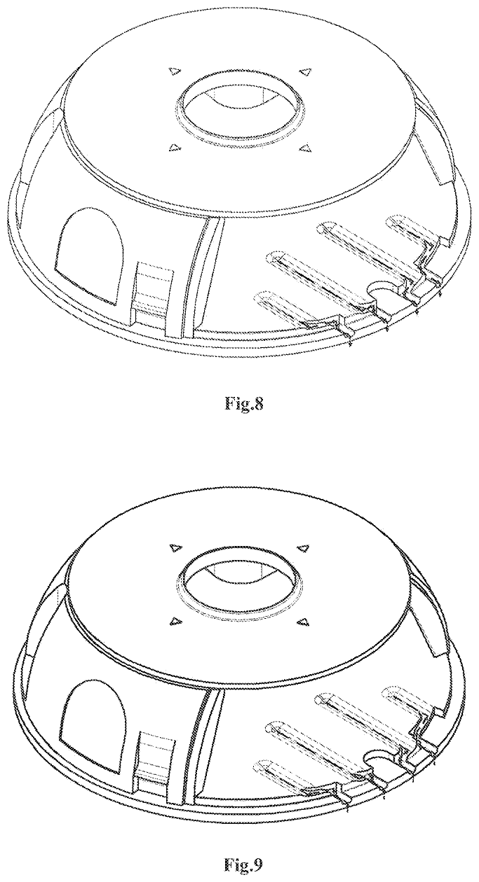

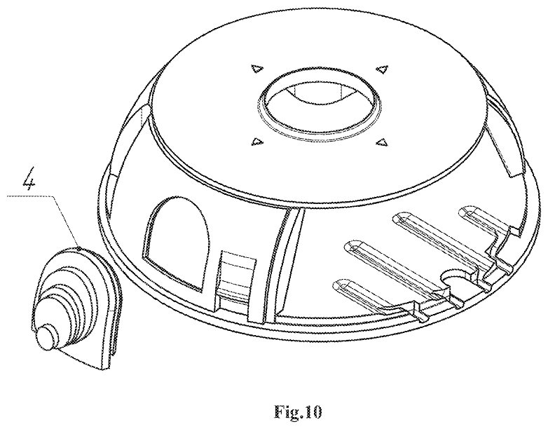

FIG. 9 shows a path that does not allow water to penetrate inside the case;

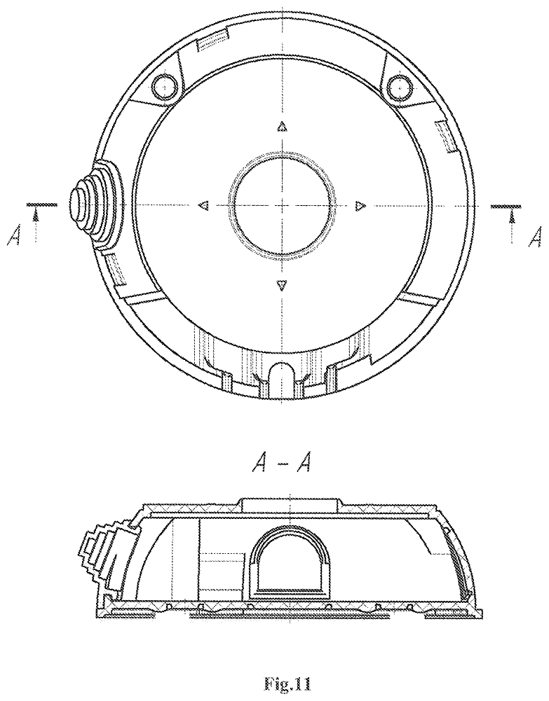

FIG. 10 shows the mounting case/box and the place for installing the seal;

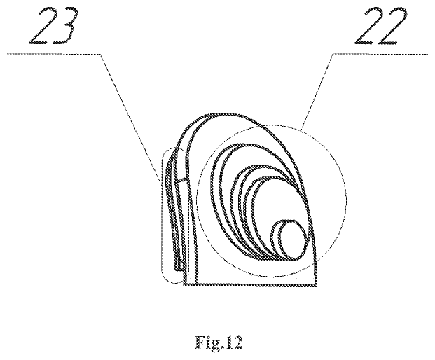

FIG. 11 is a diagram of a back of the case with a side seal;

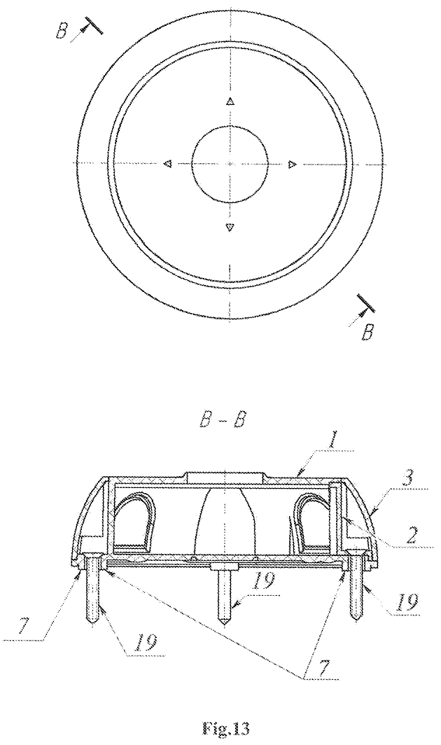

FIG. 12 is a view of the side seal, and

FIG. 13 is a diagram of a mounting case with the construction of mounting legs,

Wherein:
1—case/box body
2—case/box insert
3—case/box cover
4—side seal
5—the bottom of the box/case
6—drainage channels
7—fixing legs
8—window under the break
9—side wall sector
10—walls for fixing cable connectors
11—guides
12—mounting base
13—latches
14—holes for fixing the base and insert to the wall
15—lid lock
16—position indicator (landmarks)
17—opening windows
18—retainer
19—fasteners
20—recess for the retainer
21—hole for entering cable connectors
22—divisions for breaking out for corrugation or cable entry
23—fixing groove, and
24—logo.

The universal mounting box/case for video cameras (FIGS. 1, 2) is formed having spherical shape and consists of three main parts: the base of the box/case 1, the insert for the box/case 2 and the lid of the box 3. The fourth part: the side gasket 4 is used if it is necessary to seal the side feed and improve aesthetics (used from one to four pieces). The case/box body is the main structural element.

Thanks to the use of non-standard design solutions, as well as special equipment for manufacturing, the body of the case/box 1 is made as a single, one-piece structure, combining the bottom of the box/case 5 with drainage channels 6, fixing legs 7 and windows under the breakout 8 (at the bottom of the box), the side sector walls 9 with walls 10 for fixing cable connectors, a lower window for switching cable connectors and with three windows for breakout 8 (along the side walls of the box), as well as mounting base 12 (the video camera is installed on the mounting base outside the mounting box thanks to the use of self-tapping screws) with a hole for entering cable connectors 21. By combining the bottom of the box/case, the side wall sector and the mounting base into a single one-piece structure, in places with increased danger of water penetration (the bottom of the box, the mounting base and the side wall sector), a tight connection is achieved, which provides reliable protection of the cable connectors.

The side walls 9 of the mounting box are combined with the bottom of the box 5 and the mounting base 12 (end cover) into a single design solution. This design is made by injection molding on injection molding machines using specialized equipment.

The drainage channels 6 are made on the inner surface of the bottom of the case/box 5 and are the gutters that change their direction in order to make it difficult for water to enter the case/box (FIGS. 8 and 9). The practice of using outdoor mounting boxes/cases with a high degree of moisture protection has shown that in most cases moisture penetrates into the case/box. To eliminate this negative phenomenon, a system of drainage channels is provided in the design of the universal case/box. If it penetrates s inside the case/box, water immediately flows out due to the force of gravity. The ingress of water into the case/box through the channels is difficult due to the complex geometry of these channels. The path of the outflow of water from the case/box to the outside (street) is shown in FIG. 8 by arrows. The ingress of water into the inside of the case/box is prevented due to the geometry of the drainage channels, which change their direction several times, have height differences, as well as sharp angles in the direction of water flow from the street side to the inside of the case/box.

Obstacles preventing the penetration of water from the street side and the path preventing it from entering the inside of the case/box are shown in FIG. 9 by arrows.

The box/case insert 2 (FIGS. 5, 6) is a semicircular part of the housing sector; it has special latches 13 on the inner side, intended for secure fixation in the case/box body. The latches are made in the form of triangular flat projections. The latches 18 for the cover on the insert and the sides of the body are made in the form of protrusions. If necessary, it is possible to break out the window 8 to supply the corrugation or cable from the bottom of the box/case. Also, the case/box insert has holes 14 for its final fixing together with the body to the mounting surface using fasteners. To evenly snap the case/box lid/cover, in addition to three latches on the box/case body, there is also provided a corresponding lock on the case/box insert.

The box/case insert is removed from the lower sector of the case in order to increase the convenience of cable connectors switching and to provide the possibility of carrying out maintenance of the video camera without removing it from the mounting case/box.

When the insert is snapped onto the box/case body, the insert latches, due to the elastic deformation of the plastic and the pressure from the installer, slide along the walls of the body to fix the cable connectors. At the initial moment of the snapping process, the insert is compressed. After the latches overcome the boundaries of the walls of the case, the insert is unclenched again, due to which it is securely fixed in the case. When removing the insert from the housing, the described process is carried out in the reverse order.

On the lid/cover of the box/case 3 (FIG. 7) there are four windows for breaking out 8 (at an angle of 90 degrees), if it is necessary to bring a cable or corrugation from either side. The cover of the case/box 3 is evenly fixed on the body of the box 1 and the insert of the box 2 using four latches located on the four sides of the product at an angle of 45 degrees. To ensure the correct position of the box lid/cover during its installation on the body, there are guides provided that are aligned with the recesses for the screws on the body and the insert. This eliminates the possibility of incorrect alignment of the box lid/cover with the case/box body and insert.

On the inner side of the lid/cover at an angle of 45° relative to each other, the lid clips are located. The location of the latches at an angle of 45° contributes to the uniform fixation of the lid on the case/box body and the insert from four sides.

In the process of closing the lid/cover on the case/box body and insertion of the case/box, the lid latches slide over the surface of the body and insert latches, creating a characteristic “click” sound signal, indicating that the lid/cover snapping process is completed correctly.

When closed, the lid/cover latches are located under the body and insert latches, which prevents unintentional opening.

To facilitate the removal of the case/box lid/cover, openings 17 are provided, made in the form of rectangular cutouts at the base of the lid. To remove the cover/cover, a flat screwdriver is alternately placed in the windows for opening and rotated through an angle of 90 degrees.

The side seal 4 (FIG. 12) is designed to seal and improve the aesthetics of the case/box in the case of feed of a corrugation or cable. When installing the side seal in place of the breakaway ports, the fixing groove 23 reliably closes the perimeter of the window broken in the case/box or in the box insert, and the fixing shoulder is securely fastened in the breakaway case/box port.

The side seal is designed in such a way that it has several steps for supplying various communications (for example, cables from 5 mm, corrugation with a diameter of 20 mm, corrugation with a diameter of 16 mm).

In the overwhelming majority of cases, the corrugation, like the cable to reduce the likelihood of water getting into the case/box, is fed from below. When approaching from below, depending on the type of the supplied element, for example, a corrugation with a diameter of 20 mm or a flat cable, corresponding divisions are cut off in advance in the lateral seal, the corresponding element is inserted into it, and after installing the case/box itself, a box insert is positioned on the fixing groove of the seal with a port being previously broke away. Then the insert with a seal mounted in its groove is fixed in the box body.

In the case of bringing the necessary element from above or from the side, the corresponding seal is also cut off in advance in the side seal, the corresponding element is inserted into it, and after installing the case/box itself, the seal with this element is mounted inside its body.

In the case of using one or more oil seals (side seals), the geometry of the case/box cover repeats the geometry of the oil seals, creating a sense of solidity of the structure.

The design of the case/box allows it to be fixed to the mounting surface both with self-tapping screws and various types of dowel-nails that are popular among installers.

The fixing legs 7 are made in such a way that they make it possible to move the bottom of the case/box body away from the wall by several millimeters, thereby allowing the water flowing along the wall to pass between the wall and the end of the case/box body. The design of the mounting legs is shown in FIG. 13.

To exclude significant differences between the size of the case/box and the video camera, the industrial design of the product assumes several standard sizes (for example, for video cameras with a mounting diameter of up to 98 mm, up to 120 mm, etc.).

The unification of this mounting case/box with cameras of various form factors is achieved due to the elimination of the use of grids of fixing holes intended for attaching a certain camera to a certain case/box, as is implemented in the construction of metal analogs. The designs of plastic analogs allow the installation of various video cameras, but they are not specialized products for video surveillance systems. This product is designed specifically for video surveillance systems and can be used in conjunction with video cameras of various standard sizes.

In the described product, the cameras are attached to the surface of the case/box body due to the use of self-tapping screws, which allows you to install any camera on the case/box in which the largest diameter of the mounting surface does not exceed a certain standard size. If the largest diameter of the camera mounting surface exceeds the limit size specified in the instructions for the case/box by up to 6 mm, the use of this product is possible if the case/box is used without the box cover. In case of refusal to use the cover, the mounting case/box retains its functionality. The case/box lid enhances the aesthetics of the product and provides additional protection against vandals and moisture.

Simplification of the installation of CCTV cameras is achieved by increasing the ease of installation and reducing the number of operations performed by the installer, thanks to the use of a special design of the case/box base. The base of the case/box is designed for wall mounting and at the same time a video camera is mounted on it. The base of the box has a window at the bottom that allows you to easily connect the cable connectors and then close them inside the case/box using the case/box insert and case/box cover. Thanks to this constructive solution, it is possible to carry out maintenance of cable connectors without dismantling the camera. This feature of the product also expands the variations in practical application, increasing its versatility, which is not in the design of analogues.

The aesthetics of the back case/box is significantly improved in comparison with the design of analogs, thanks to the use of a truncated sphere as a geometric shape, which harmonizes the perception of the video camera.

To fix the mounting case/box to the mounting surface with self-tapping screws, it is necessary to attach it to the attachment point, aligning it with the supplied connectors, then fix it with self-tapping screws for the two upper holes.

If the case/box needs to be fixed with dowel-nails, then in this case it is possible to break out the jumpers for the passage of the dowel-nails. After that, the case/box is fixed by the two upper holes by analogy with fastening with self-tapping screws.

If necessary, the central lower hole serves as an additional fixing point in the case/box body.

In the case of cable entry from the wall, they are threaded through a hole previously cut out in the bottom of the case/box body, one of five, depending on convenience. After that, the cable connector is crimped. Next, the cable connectors from the camera are threaded into the corresponding hole on the case/box body, after which the camera is attached to the case/box surface using self-tapping screws (if desired, the camera can be installed on the case/box body before the body is attached to the wall). Then the connectors of the camera are connected with connectors that are removed from the wall, or brought in from one or more sides. Then turn on the video camera and adjust its final position. The cable connectors are then placed inside the case/box body, securing them behind the cable connector walls to prevent them from falling out of the case/box. Next, the case/box insert is installed in the case/box body, applying an effort directed towards the center of the case/box body until a characteristic “click” sound appears, signaling the correct installation of the insert. Then, the final fixation of the case/box insert and the case/box body is performed using the two lower holes to the wall. Next, the case/box cover is placed on the resulting structure. After that, a force is applied to the lid of the case/box in a circle, directed towards the wall until a characteristic click, indicating that the latches are fixed. In addition to a click, the absence of distortions between the body and the lid/cover confirms a reliable fixation.

Dismantling is carried out by prying with a flat screwdriver behind the small opening windows located at the bottom of the case/box lid. In this case, the screwdriver handle is turned 90 degrees, and the force vector is directed from the base of the case/box.

In case of cable outlet from the wall side, at the end of the case/box there are five possible entry points, depending on convenience. These entry points are designed as breakout points. One of them is located in the center and one on each side. Thanks to this solution, the variability of the cable entry is achieved without changing the position of the case/box.

Fixation of the case/box lid/cover on the base of the box and the insertion of the case/box is carried out using latches located on the four sides of the product at an angle of 45 degrees. In the same way, the case/box insert is fixed at the base of the case/box, only by means of two latches.

The anti-vandalism protection of this product is achieved due to its non-standard design. When the case/box cover is put on, it is not possible to get to the fasteners, and to remove the cover, you will need a flat screwdriver with a width of at least 5 mm.

Reliable fixation of the case/box insert and case/box lid/cover in their seats is signaled by a characteristic sound signal: “click” produced by the latches during installation. This design feature is achieved due to the specific geometry of the parts.

The design of the case/box allows it to be fixed to the mounting surface both with self-tapping screws and various types of dowel-nails that are popular among installers.

In the design of the inventive mounting case/box, with the cover on, access to the fastening screws is blocked by the cover.

If necessary, to carry out maintenance of the video camera on the claimed design of the mounting case/box, the installer will need to perform the following operations:
1. Disassemble the case/box:
   Insert a flat screwdriver into the “openings for opening of the lid” and, by turning the screwdriver 90 degrees along its axis alternately in 3-4 windows, remove the case/box lid from the case/box body;
   Unscrew one or two fasteners from the hole for fastening the base and insert to the wall;
   Remove the insert from the case/box body;
2. Remove interfaces and cable connectors;
3. Establish the cause of the problem and eliminate it;
4. Place the cable connectors back into the case/box;
5. Assemble the case/box:
   close the window for switching cable connectors by inserting the case/box by applying a force on the insert directed towards the center of the case/box body until a characteristic click sound appears, indicating that the insert latches are fixed relative to the body latches;
   screw one or two fasteners into the holes for fastening the base and insert to the wall;
   fix the case/box lid on the case/box body by pressing in a circle direction to fix it.

Thus, the advantages of a universal mounting case/box for video cameras are:
1) Application for video cameras of various form factors;
2) Simplification and acceleration of the installation of cameras;
3) Improving the safety of installation work:
   reduction of psychophysical fatigue during installation work
   reducing the risk of injury during installation work;
   reducing the risk of damage to expensive equipment during installation work;
   reducing the risk of falling tools and fasteners during installation work;
4) The ability to carry out maintenance of the video camera without removing it from the mounting case/box;
5) Aesthetics (harmonious design complements the look of the video camera);
6) Convenience of laying cable connectors;
7) Vandal-proof structure;
8) The presence of sound signals informing about the correct assembly of product elements;
9) The possibility of using various options for fasteners;
10) Preservation of the functionality of the case/box, both in the case of its use with a “box lid” and without it;
11) Possibility of applying a seal to the hole for entering cable connectors;
12) No need to use a sealing gasket;
13) The presence of drainage channels;
14) Variability of the cable connection.

1. Universal mounting case for video cameras including a case/box body with a hole on an upper part for entering cable connectors, characterized in that it also contains a case/box cover, a case/box insert and a case/box bottom, the case/box insert is a part of a side sector of the body, an inner side of the case/box insert is provided with latches adapted for reliable fixation in the case/box body to provide access to cable connectors during installation and maintenance of the camera without disturbing its focus.

2. The universal mounting case for video cameras according to claim 1, characterized in that the mounting case/box is made in a form of a truncated sphere.

3. The universal mounting case for video cameras according to claim 1, characterized in that the case/box body is formed as a one-piece structure.

4. The universal mounting case for video cameras according to claim 1, characterized in that the bottom of the case/box includes drainage channels located on an inner surface of the bottom of the case/box, wherein the drainage channels are in the form of gutters changing their direction and height to prevent water to enter the case/box.

5. The universal mounting case for video cameras according to claim 1, characterized in that the body, cover and insert contain breakaway ports for commutation of cable connectors.

6. The universal mounting case for video cameras according to claim 1, characterized in that the bottom of the case/box contains fixing legs protruding outwardly from a bottom plane by a few millimeters, enabling to move the bottom of the case/box body away from a wall.

7. The universal mounting case for video cameras according to claim 1, characterized in that the case/box body, cover and insert contain fasteners, including retainers, latches, recesses and guides provided for reliable fixation of all parts of the case/box.

8. The universal mounting case for video cameras according to claim 1, characterized in that it also contains a side seal installed in breakout ports, the side seal having several steps for supplying various communications.

9. The universal mounting case for video cameras according to claim 2, characterized in that the steps of the side seal are formed having diameters of 5 mm, 16 mm and 20 mm.

10. The universal mounting case for video cameras according to claim 1, characterized in that at a base of the cover there are provided openings having a form of rectangular cutouts.
